(19) United States
(12) Patent Application Publication
(10) Pub. No.: US 2025/0109267 A1
(43) Pub. Date: Apr. 3, 2025

(54) Shrink Film, Container, And Ink Jet Printing Apparatus

(71) Applicant: SEIKO EPSON CORPORATION, Tokyo (JP)

(72) Inventors: Emi TAKEUCHI, Shiojiri (JP); Chigusa SATO, Matsumoto (JP)

(21) Appl. No.: 18/898,789

(22) Filed: Sep. 27, 2024

(30) Foreign Application Priority Data
Sep. 28, 2023 (JP) 2023-167258

(51) Int. Cl. C08J 7/04; B41J 3/407; B41J 11/00; C08J 5/12; C08J 7/052; C08J 7/06; C09D 11/322; C09D 11/38

(52) U.S. Cl. CPC C08J 7/0427; B41J 3/407; B41J 11/00214; C08J 5/121; C08J 7/052; C08J 7/065; C09D 11/322; C09D 11/38; C08J 2367/06

(57) ABSTRACT

A shrink film is shrunk in a first direction by heat and has a quadrilateral shape in plan view with a first and a second side extending in the first direction. The shrink film includes, in plan view, a first region that is defined by a contour including a portion of the first side and a portion of the second side and has a coating of a radiation-curable ink jet ink formed therein, and a second region that has a rectangular shape with two opposing sides defined by a portion of the first side and a portion of the second side and has no coating of the radiation-curable ink jet ink or a coating of the radiation-curable ink jet ink formed therein with a smaller thickness than the coating in the first region.

The present application is based on, and claims priority from JP Application Serial Number 2023-167258, filed Sep. 28, 2023, the disclosure of which is hereby incorporated by reference herein in its entirety.

### BACKGROUND

### 1. Technical Field

The present disclosure relates to a shrink film, a container, and an ink jet printing apparatus.

### 2. Related Art

In wrapping commodity products, such as beverages, foods, seasonings, cosmetics, and other daily necessities, some types of film are used as a label attached to containers made of resin, glass, metal, or the like. One of such types is called shrink film (or shrinkable film), which is attached to containers by being shrunk to tighten and adhere to the container. Many shrink films are subjected to printing according to the product, typically before being attached to the container, that is, before being shrunk.

For example, JP-A-2019-152805 discloses the use of UV-curable ink to form images with an uneven surface on a shrink film in an attempt to improve the impression of the label.

From the viewpoint of enabling low-cost, small-lot production, a technique using an ink jet method is desired for printing on shrink films. Also, printing with radiation-curable ink, which can produce more high-quality images and have higher curability than aqueous ink, has been studied. However, the coating of radiation-curable ink printed on a film to be shrunk can crack as the film shrinks.

### SUMMARY

An aspect of the present disclosure provides a shrink film that is shrunk in a first direction by heat and has a quadrilateral shape in plan view with a first and a second side extending in the first direction. The shrink film includes, in plan view, a first region that is defined by a contour including a portion of the first side and a portion of the second side and has a coating of a radiation-curable ink jet ink formed therein, and a second region that has a rectangular shape with two opposing sides defined by a portion of the first side and a portion of the second side and has no coating of the radiation-curable ink jet ink or a coating of the radiation-curable ink jet ink formed therein with a smaller thickness than the coating in the first region.

Another aspect of the present disclosure provides a container including a container body and the shrink film disposed on the periphery of the container body by heat shrinking.

Further aspect of the present disclosure provides an ink jet printing apparatus including a head that ejects a radiation-curable ink jet ink and a control unit that controls the head. The control unit performs a printing mode of applying the radiation-curable ink jet ink onto a film that is shrunk in a first direction by heat and has a quadrilateral shape in plan view with a first and a second side extending in the first direction. In the printing mode, the control unit forms a first region that is defined by a contour including a portion of the first side and a portion of the second side in plan view and has a coating of the radiation-curable ink jet ink formed therein, and a second region that has a rectangular shape in plan view with two opposing sides defined by a portion of the first side and a portion of the second side and has no coating of the radiation-curable ink jet ink or a coating of the radiation-curable ink jet ink formed therein with a smaller thickness than the coating in the first region.

### BRIEF DESCRIPTION OF THE DRAWINGS

FIG. 1 is a schematic plan view of a shrink film according to an embodiment of the present disclosure.

FIG. 2 is a schematic illustrative representation of a shrink film according to an embodiment of the present disclosure before and after shrinkage by heat.

FIG. 3 is a schematic illustrative representation of a known shrink film before and after shrinkage by heat.

FIG. 4 is a perspective view of an ink jet printing apparatus that can produce a shrink film according to an embodiment of the present disclosure.

FIG. 5 is a front view of UV irradiation devices used in the printing apparatus depicted in FIG. 4

FIG. 6 is an illustrative representation of the irradiation devices depicted in FIG. 5 viewed in the direction indicated by arrows A.

### DESCRIPTION OF EMBODIMENTS

Some embodiments of the present disclosure will now be described. The following embodiments are exemplary implementations of the present disclosure. The implementations of the concept of the present disclosure are not limited to the following embodiments, and various modifications may be made within the scope and spirit of the disclosure. Not all the components described in the following embodiments are necessarily essential for implementing the concept of the disclosure.

### 1. Shrink Film

The shrink film disclosed herein is shrunk in a first direction by heat and has a quadrilateral shape with a first and a second side extending in the first direction in plan view. Also, in plan view, the shrink film disclosed herein includes a first region in which a coating of a radiation-curable ink jet ink is formed, and a second region has no coating of the radiation-curable ink jet ink or a coating of the radiation-curable ink jet ink with a smaller thickness than the coating in the first region.

### 1.1. Shape and Material of Shrink Film

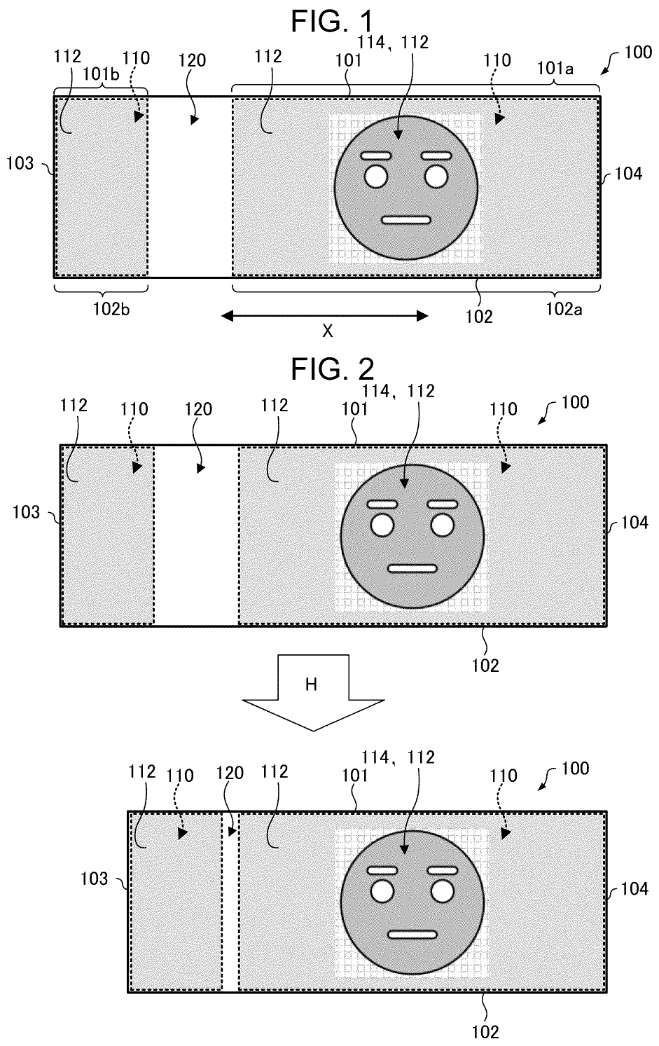

The shrink film disclosed herein is shrunk in a first direction by heat. FIG. 1 is a schematic plan view of a shrink film 100 according to an embodiment of the present disclosure. The shrink film 100 is shrunk in a first direction X by heat.

The shrink film 100 has a quadrilateral shape with a first side 101 and a second side 102 that extend in the first direction X in plan view. The first side 101 and the second side 102 are not necessarily straight or parallel in a strict sense but are, in some embodiments, defined by parallel and straight line segments. The quadrilateral shape mentioned herein is a shape formed by four sides. The shrink film 100 may have the shape of a parallelogram in plan view and is, in some embodiments, rectangular.

In the embodiment illustrated in FIG. 1, the shrink film 100 has a rectangular shape with a third side 103 and a fourth side 104, both perpendicular to the first direction X in plan view. In an embodiment (not shown), the shrink film 100 may have the shape of a parallelogram with a third and a fourth side, both intersecting the first direction X in plan view.

The shrink film 100 may shrink, for example, 5% or more in the first direction X when heated to 80° C. In some embodiments, the shrink film 100 shrinks 10% or more, for example, 15% or more or 30% or more when heated to 80° C. The temperature for shrinking the shrink film 100 is not particularly limited.

The degree of shrinkage of the shrink film 100 by heat can be determined using the equation presented below. The degree of the shrinkage may be measured in any direction and is, in the present disclosure, within the aforementioned range in the first direction X. When an oriented film in which resin is oriented by stretching an unoriented film in the orientation direction is heated, the stress caused by the molecular orientation is released, and the film shrinks to the dimensions before stretching. The degree and the direction of the shrinkage can be adjusted, for example, in a stretching step in the process of producing the shrink film 100, and the direction of shrinkage may be in, but is not limited to, either the machine direction or the width direction or both.

Degree of Shrinkage (%)=[(length before shrinkage)−(length after shrinkage)]/(length before shrinkage)

Examples of the material of the shrink film 100 include, but are not limited to, polyolefin resin, polyester resin, polystyrene resin, and polyvinyl chloride resin. For example, a shrink film may be formed of a polyester resin produced by condensation polymerization of a dicarboxylic acid component and a polyhydric alcohol component.

Examples of the dicarboxylic acid component include, but are not limited to, aromatic dicarboxylic acids and their salts, such as terephthalic acid, isophthalic acid, 1,4- or 2,6-naphthalenedicarboxylic acid, and sodium 5-sulfoisophthalate; dialkyl esters, diaryl esters, and other esterified derivatives of aromatic dicarboxylic acids; and aliphatic dicarboxylic acids, such as dimer acid, glutaric acid, adipic acid, sebacic acid, azelaic acid, oxalic acid, and succinic acid.

In addition to these, oxycarboxylic acids, such as p-oxybenzoic acid; and multivalent carboxylic acids, such as trimellitic anhydride and pyromellitic dianhydride may be used.

Examples of the polyhydric alcohol component include, but are not limited to, alkylene glycols, such as ethylene glycol, diethylene glycol, dimer diol, propylene glycol, triethylene glycol, 1,4-butanediol, neopentyl glycol, 1,3-cyclohexanedimethanol, 1,4-cyclohexanedimethanol, 1,6-hexanediol, 3-methyl-1,5-pentanediol, 2-methyl-1,5-pentanediol, 2,2-diethyl-1,3-propanediol, 1,9-nonanediol, and 1,10-decanediol; ethylene oxide adducts of bisphenol compounds or their derivatives; and trimethylolpropane, glycerin, pentaerythritol, polyoxytetramethylene glycol, and polyethylene glycol.

In addition to these, trimethylolethane, diglycerin, and other polyhydric alcohols may be used.

Examples of the polystyrene resin include, but are not limited to, polystyrene; poly(alkylstyrene), such as poly(p-, m-, or o-methylstyrene), poly(2,4-, 2,5-, 3,4-, or 3,5-dimethylstyrene), and poly(p-tert-butylstyrene); poly(halogenated styrene), such as poly(p-, m-, or o-chlorostyrene), poly(p-, m-, or o-bromostyrene), poly(p-, m- or o-fluorostyrene), and poly(o-methyl-p-fluorostyrene); poly(halogen-substituted alkylstyrene), such as poly(p-, m-, or o-chloromethylstyrene); poly(alkoxystyrene), such as poly(p-, m-, or o-methoxystyrene) and poly(p-, m-, or o-ethoxystyrene); poly(carboxyalkylstyrene), such as poly(p-, m-, or o-carboxymethylstyrene); poly(alkyl ether styrene), such as poly(p-vinylbenzyl propyl ether); poly(alkylsilylstyrene), such as poly(p-trimethylsilylstyrene); and poly(vinylbenzyldimethoxy phosphide).

The shrink film 100 may contain a rubber component. Examples of the rubber component include, but are not limited to, rubber produced by partially or fully hydrogenating the butadiene moieties of a styrene-butadiene block copolymer, styrene-butadiene copolymer rubber, styrene-isoprene block copolymers, rubber produced by partially or fully hydrogenating the isoprene moieties of a styrene-isoprene block copolymer, methyl acrylate-butadiene-styrene copolymer rubber, and methyl methacrylate-alkyl acrylate-butadiene-styrene copolymer rubber.

In some embodiments, the shrink film 100 contains polyethylene terephthalate (PET). Such a shrink film tends to shrink to a larger degree.

In some embodiments, the shrink film 100 is an oriented film. The oriented film may be uniaxially oriented or biaxially oriented. The orientation may be performed in, but not limited to, a method including a stretching step of stretching an unoriented film 2.0 to 8.0 times, for example, 2.5 to 6.0 times, at a temperature of (Tg−20°) C to (Tg+40°) C in a direction (first direction X) in which the resulting film is made shrinkable. Tg is the glass transition temperature of the resin forming the shrink film 100. After the stretching step, the film may be heat-treated at a temperature of 50° C. to 110° C. while being 0% to 15% stretched or relaxed.

### 1. 2. First Region

The shrink film 100 includes a first region 110 that is defined by a contour including a portion of the first side 101 and a portion of the second side 102 and has a coating 112 of a radiation-curable ink jet ink formed therein. In the embodiment illustrated in FIG. 1, the shrink film 100 includes two first regions 110. The number of first regions 110 may be one or three or more provided that the shrink film has a second region 120, described later.

In the illustrated embodiment, the contour of the first region 110 on the left has a rectangular shape defined by a side shared with the second region 120, the third side 103 of the shrink film 100, a portion 101b of the first side 101, and a portion 102b of the second side 102. Similarly, the contour of the first region 110 on the right has a rectangular shape defined by a side shared with the second region 120, the fourth side 104 of the shrink film 100, a portion 101a of the first side 101, and a portion 102a of the second side 102.

The length of the portion of the first side 101 forming the contour of the first region 110 may be, but is not limited to, 70% to 95% of the length of the first side 101 and is, in some embodiments, 80% to 85% or 85% to 90%. The same applies to the length of the portion of the second side 102 forming the contour of the first region 110. When a plurality of first regions 110 are formed, the total length of the portions of the first side 101, each forming part of the contours of the respective first regions 110, or the total length of the portions of the second side 102, each forming part of the contours of the respective first regions 110, may be within the aforementioned range. More specifically, in the illustrated embodiment, the sum of the portion 101a and portion 101b of the first side 101 may be in the aforementioned range, and the sum of the portion 102a and portion 102b of the second side 102 may be in the aforementioned range.

A coating 112 of a radiation-curable ink jet ink is formed over the entirety of the first region 110. In the shrink film 100 of the illustrated embodiment, the coating 112 of the radiation-curable ink jet ink in the first region 110 may form an image 114. The image 114 can enhance the design aesthetics of the shrink film 100 as a label. An image is anything that can be visually recognized, such as a figure, a picture, a letter or letters, or a symbol.

The thickness of the coating 112 of the radiation-curable ink jet ink in the first region 110 may be 5 μm or more, for example, 10 μm or more or 15 μm or more. However, the upper limit of the thickness of the coating 112 of the radiation-curable ink jet ink in the first region 110 may be, but is not limited, 500 μm or less, for example, 300 μm or less or 200 μm or less.

When the coating 112 in the first region 110 has such a thickness, the first region 110 is less likely to shrink and, accordingly, reduces cracks in the coating 112 of the radiation-curable ink jet ink in the first region 110.

### 1. 3. Second Region

The shrink film 100 includes a second region 120 that has a rectangular shape with two opposing sides defined by a portion of the first side 101 and a portion of the second side 102 and has no coating of the radiation-curable ink jet ink or a coating of the radiation-curable ink jet ink with a smaller thickness than the coating in the first region. In the embodiment illustrated in FIG. 1, the shrink film 100 includes a single second region 120. In an embodiment, two or more second regions 120 may be formed.

The length of the portion of the first side 101 forming the contour of the second region 120 may be, but is not limited, 2% to 30% of the length of the first side 101 and is, in some embodiments, 5% to 20% or 5% to 15%. In other words, the length of the second region 120 in the first direction X may be 1/50 to 3/10 of the length of the shrink film 100 in the first direction X and, in some embodiments, 1/20 to ⅕ or 1/20 to 15/100. The same applies to the length of the portion of the second side 102 forming part of the contour of the second region 120. When a plurality of second regions 120 are formed, the total length of the portions of the first side 101, each forming part of the contours of the respective second regions 120, or the total length of the portions of the second side 102, each forming part of the contours of the respective second regions 120, may be within the aforementioned range.

The second region 120 with such a length in the first direction X can reduce cracks in the coating 112 of the radiation-curable ink jet ink formed in the first region 110 and ensure sufficient shrinkage.

The second region 120 has no coating of the radiation-curable ink jet ink or a coating of the radiation-curable ink jet ink with a smaller thickness than the coating in the first region 110. In the embodiment illustrated in FIG. 1, the second region 120 has no coating of the radiation-curable ink jet ink.

When the second region 120 has no coating of the radiation-curable ink jet ink or a coating of the radiation-curable ink jet ink with a smaller thickness than the coating in the first region 110, the second region 120 shrinks preferentially to the first region 110 and thus can reduce cracks in the coating 112 of the radiation-curable ink jet ink formed in the first region 110. This effect is more noticeable when the second region 120 has no coating of the radiation-curable ink jet ink.

When the second region 120 has a coating of the radiation-curable ink jet ink, the thickness of the coating is 5 μm or less and may be 3 μm or less or 2 μm or less. However, the lower limit of the optionally formed coating in the second region 120 may be, but is not limited, 0.1 μm or more, for example, 0.5 μm or more or 1 μm or more. Such a coating of the radiation-curable ink jet ink in the second region 120 allows the second region 120 to shrink more easily than the first region 110 and can reduce cracks in the coating 112 of the radiation-curable ink jet ink formed in the first region 110.

### 1. 4. Radiation-Curable Ink Jet Ink

The radiation-curable ink jet ink is cured by irradiation with radiation. The radiation may be ultraviolet light, an electron beam, infrared light, visible light, or X-rays. In some embodiments, ultraviolet light is used as the radiation because of the prevalence and availability of the radiation source and the materials suitable for curing with UV light.

The radiation-curable ink jet ink contains, but not limited to, a polymerizable compound, a polymerization initiator, a polymerization inhibitor, a sensitizer, a surfactant, a coloring material, and a dispersant, for example. The radiation-curable ink jet ink does not necessarily contain all of these constituents and may contain only some of them. The constituents of the radiation-curable ink jet ink will now be described.

### (1) Polymerizable Compound

Those having polymerizable functional groups are generally referred to as polymerizable compounds. Polymerizable compounds include monofunctional monomers with one polymerizable functional group in the molecule and multifunctional monomers with a plurality of polymerizable functional groups in the molecule. The polymerizable compound used herein may be an individual one or a combination of two or more polymerizable compounds.

The weighted average glass transition temperature of the polymerizable compounds in the radiation-curable ink jet ink is 20° C. to 70° C. and, in some embodiments, may be 25° C. to 65° C., for example, 30° C. to 60° C. or 40° C. to 50° C. When the weighted average glass transition temperature is 20° C. or more, blocking resistance is improved. Also, when the weighted average glass transition temperature is 20° C. or more, the ink tends to exhibit improved curability. Additionally, when the weighted average glass transition temperature is 70° C. or less, cracks are less likely to be formed.

The glass transition temperature of a polymerizable compound refers to the glass transition temperature of the homopolymer of the polymerizable compound. The weighted average glass transition temperature of polymerizable compounds can be controlled by the glass transition temperatures of the homopolymers of the polymerizable compounds to be used and their proportions by mass.

It will now be explained how to calculate the weighted average glass transition temperature of the homopolymers of polymerizable compounds. The weighted average glass transition temperature of the homopolymers is expressed as Tg^{A11}, the glass transition temperature of a polymerizable compound is expressed as Tg^{N}, and the proportion by mass of the polymerizable compound is expressed as X^{N} (wt %). N is a variable from 1 to the number of polymerizable compounds in the radiation-curable ink jet ink, assigned in turn. For example, when three polymerizable compounds are used, the glass transition temperatures of their homopolymers are Tg¹, Tg², and Tg³. The weighted average glass transition temperature Tg^{A11} of homopolymers is the sum of the products of the glass transition temperature Tg^{N} of the homopolymer of each polymerizable compound and the proportion X^{N} by mass of the polymerizable compound. Thus, the following equation (1) holds.

$$T {g}^{All} = \sum ( {Tg}^{N} \times {X}^{N} ) \qquad ( 1 )$$

The glass transition temperature of the homopolymer of a polymerizable compound can be measured by differential scanning calorimetry (DSC) in accordance with JIS K7121. More specifically, a sample prepared by polymerizing a monomer to the extent that its homopolymer exhibits a constant transition temperature is measured with a measurement apparatus, for example, Model DSC6220 manufactured by Seiko Instruments Inc.

The polymerizable compound content of the radiation-curable ink jet ink may be 55% to 85% by mass, for example, 60% to 80% by mass or 65% to 75% by mass, relative to the total mass of the ink. The radiation-curable ink jet ink containing such an amount of polymerizable compounds tends to improve blocking resistance or have improved curability.

### (1-1) Monofunctional Monomers

Examples of monofunctional monomers include, but are not limited to, nitrogen-containing monofunctional monomers, aromatic group-containing monofunctional monomers, and alicyclic structure-containing monofunctional monomers. Also, such monofunctional monomers may be replaced with other monofunctional monomers, or the monofunctional monomers may include other monofunctional monomers.

The amount of monofunctional monomers may be 30% by mass or more, for example, 40% by mass or more, relative to the total mass of the polymerizable compounds. The use of monofunctional monomers in a proportion of 30% by mass or more tends to improve blocking resistance.

Exemplary monofunctional monomers used in the radiation-curable ink jet ink include, but are not to, the following.

### (1-1-1) Nitrogen-Containing Monofunctional Monomer

The polymerizable compounds may include a nitrogen-containing monofunctional monomer. The nitrogen-containing monofunctional monomer tends to improve the adhesion of the coating, thereby improving blocking resistance.

Examples of the nitrogen-containing monofunctional monomer include, but are not limited to, nitrogen-containing monofunctional vinyl monomers, such as N-vinylcaprolactam (n-VC), N-vinylformamide, N-vinylcarbazole, N-vinylacetamide, vinyl methyl oxazolidinone (VMOX), and N-vinylpyrrolidone; nitrogen-containing monofunctional acrylate monomers, such as acryloylmorpholine (ACMO); and nitrogen-containing monofunctional (meth)acrylamide monomers, such as (meth)acrylamide, N-hydroxymethyl(meth)acrylamide, diacetone acrylamide, N,N-dimethyl (meth)acrylamide, and dimethylaminoethyl acrylate benzyl chloride quaternary salt.

In an embodiment, the radiation-curable ink jet ink may contain either a nitrogen-containing monofunctional vinyl monomer or a nitrogen-containing monofunctional acrylate monomer, particularly a monomer having a nitrogen-containing heterocyclic structure, such as vinyl methyl oxazolidinone, acryloylmorpholine, or N-vinylcaprolactam. In some embodiments, vinyl methyl oxazolidinone is contained. Such a nitrogen-containing monofunctional monomer reduces the viscosity of the ink. Consequently, the ejection consistency of the radiation-curable ink jet ink tends to be improved. Also, the radiation-curable ink jet ink containing such a nitrogen-containing monofunctional monomer tends to improve blocking resistance or shrink properties or exhibit improved curability. Furthermore, vinyl methyl oxazolidinone, which is a monomer with low viscosity at room temperature, tends to improve the ejection consistency of the ink.

The nitrogen-containing monofunctional monomer content of the radiation-curable ink jet ink may be 15% to 45% by mass, for example, 20% to 40% by mass or 25% to 35% by mass, relative to the total mass of the ink. The radiation-curable ink jet ink containing such an amount of nitrogen-containing monofunctional monomer tends to improve blocking resistance or exhibit improved curability.

### (1-1-2) Aromatic Group-Containing Monofunctional Monomer

Examples of aromatic group-containing monofunctional monomers include, but are not limited to, phenoxyethyl (meth)acrylate, benzyl (meth)acrylate, alkoxylated 2-phenoxyethyl (meth)acrylate, ethoxylated nonylphenyl (meth)acrylate and other alkoxylated nonylphenyl (meth)acrylates, EO-modified p-cumylphenol (meth)acrylate, and 2-hydroxy-3-phenoxypropyl (meth)acrylate.

In an embodiment, phenoxyethyl (meth)acrylate or benzyl (meth)acrylate may be used. In some embodiments, phenoxyethyl (meth)acrylate, particularly phenoxyethyl acrylate (PEA), is used. Such an aromatic group-containing monofunctional monomer tends to increase the solubility of the polymerization initiator and improve the curability of the ink composition. In particular, the solubility of acylphosphine oxide-based polymerization initiators and thioxanthone-based polymerization initiators tends to be increased.

The aromatic group-containing monofunctional monomer content of the radiation-curable ink jet ink may be 25% to 55% by mass, for example, 30% to 50% by mass or 35% to 45% by mass, relative to the total mass of the ink. The radiation-curable ink jet ink containing such an amount of aromatic group-containing monofunctional monomer tends to improve blocking resistance or exhibit improved curability.

### (1-1-3) Alicyclic Structure-Containing Monofunctional Monomer

Examples of alicyclic structure-containing monofunctional monomers include, but are not limited to, monocyclic hydrocarbon-containing monomers, such as tert-butylcyclohexanol (meth)acrylate (TBCHA), 3,3,5-trimethylcyclohexyl (meth)acrylate (TMCHA), and 1,4-dioxaspiro[4.5]dec-2-ylmethyl 2-(meth)acrylate; unsaturated polycyclic hydrocarbon-containing monomers, such as dicyclopentenyl (meth)acrylate and dicyclopentenyloxyethyl (meth)acrylate; and saturated polycyclic hydrocarbon-containing monomers, such as dicyclopentanyl (meth)acrylate and isobornyl (meth)acrylate (IBXA).

In some embodiments, isobornyl (meth)acrylate, tert-butylcyclohexanol acrylate, or trimethylcyclohexyl (meth)acrylate may be used, particularly isobornyl acrylate. The radiation-curable ink jet ink containing such an alicyclic structure-containing monofunctional monomer tends to improve blocking resistance or exhibit improved curability.

The alicyclic structure-containing monofunctional monomer content of the radiation-curable ink jet ink may be 15% to 45% by mass, for example, 20% to 40% by mass or 25% to 35% by mass, relative to the total mass of the ink. The radiation-curable ink jet ink containing such an amount of alicyclic structure-containing monofunctional monomer tends to improve blocking resistance or exhibit improved curability.

### (1-2) Multifunctional Monomers

Examples of multifunctional monomers include, but are not limited to, vinyl group-containing (meth)acrylates and other multifunctional (meth)acrylates. The multifunctional monomer is not limited to these compounds, and a plurality of multifunctional monomers may be used in combination. Multifunctional monomers enhance the curability of the coating. In general, highly curable coatings are generally easy to crack when shrunk by heat. The coating containing one or more multifunctional monomers exhibits the effect of the present disclosure of reducing cracks in the coating more pronounced than the coating not containing multifunctional monomers.

The multifunctional monomer content of the radiation-curable ink jet ink may be 40% by mass or more, for example, 50% by mass or more or 60% by mass or more, relative to the total mass of the polymerizable compounds. The use of one or more multifunctional monomers in such a proportion improves the curability of the coating or blocking resistance. Exemplary multifunctional monomers used in the radiation-curable ink jet ink include, but are not limited to, the following.

### (1-2-1) Vinyl Group-Containing (Meth)Acrylate

Examples of vinyl group-containing (meth)acrylate include, but are not limited to, the compounds represented by the following formula (I):

H₂C=CR¹—CO—OR²—O—CH═CH—R³ (I)
wherein R¹ represents a hydrogen atom or a methyl group, R² represents a divalent organic residue with 2 to 20 carbon atoms, and R³ represents a hydrogen atom or a monovalent organic residue with 1 to 11 carbon atoms. Such a vinyl group-containing (meth)acrylate tends to improve blocking resistance, shrink properties, or curability.

In formula (I), the divalent organic residue with 2 to 20 carbon atoms represented by R² may be a substituted or unsubstituted linear, branched, or cyclic alkylene group with 2 to 20 carbon atoms, a substituted or unsubstituted alkylene group with 2 to 20 carbon atoms having an oxygen atom of an ether bond and/or an ester bond in the molecular structure, or a substituted or unsubstituted divalent aromatic group with 6 to 11 carbon atoms. In an embodiment, R² may be an alkylene group with 2 to 6 carbon atoms, such as ethylene, n-propylene, isopropylene, or butylene; or an alkylene group with 2 to 9 carbon atoms having an oxygen atom of an ether bond in the molecular structure, such as oxyethylene, oxy n-propylene, oxyisopropylene, or oxybutylene. In some embodiments, the compound of formula (I) may be a compound having a glycol ether chain in which R² is an oxyalkylene group with 2 to 9 carbon atoms having an oxygen atom of an ether bond in the molecular structure, such as oxyethylene, oxy n-propylene, oxyisopropylene, or oxybutylene from the viewpoint of reducing the viscosity of the ink composition and further improving the curability of the ink composition.

In the above formula (I), the monovalent organic residue with 1 to 11 carbon atoms represented by R³ may be a substituted or unsubstituted linear, branched, or cyclic alkyl group with 1 to 11 carbon atoms or a substituted or unsubstituted aromatic group with 6 to 11 carbon atoms. In some embodiments, R³ may be an alkyl group with 1 or 2 carbon atoms, that is, methyl or ethyl, or an aromatic group with 6 to 8 carbon atoms, such as phenyl or benzyl.

When the organic residues are substituted, the substituent may or may not contain carbon atoms. For the substituent containing one or more carbon atoms, the carbon atoms of the substituent are counted in the number of carbon atoms of the organic residue. Examples of the substituent containing one or more carbon atoms include, but are not limited to, carboxy and alkoxy. Examples of the substituent not containing carbon atoms include, but are not limited to, hydroxy and halogens.

Examples of the compound of formula (I) include, but are not limited to, 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth)acrylate, 1-vinyloxymethylpropyl (meth)acrylate, 2-methyl-3-vinyloxypropyl (meth)acrylate, 1,1-dimethyl-2-vinyloxyethyl (meth)acrylate, 3-vinyloxybutyl (meth)acrylate, 1-methyl-2-vinyloxypropyl (meth)acrylate, 2-vinyloxybutyl (meth)acrylate, 4-vinyloxycyclohexyl (meth)acrylate, 6-vinyloxyhexyl (meth)acrylate, 4-vinyloxymethylcyclohexylmethyl (meth)acrylate, 3-vinyloxymethylcyclohexylmethyl (meth)acrylate, 2-vinyloxymethylcyclohexylmethyl (meth)acrylate, p-vinyloxymethylphenylmethyl (meth)acrylate, m-vinyloxymethylphenylmethyl (meth)acrylate, o-vinyloxymethylphenylmethyl (meth)acrylate, 2-(2-vinyloxyethoxy)ethyl methacrylate, 2-(2-vinyloxyethoxy)ethyl acrylate (VEEA), 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate. In some embodiments, 2-(2-vinyloxyethoxy)ethyl acrylate is used in view of the ease of balancing the curability and the viscosity of the radiation-curable ink jet ink.

The vinyl group-containing (math)acrylate content of the radiation-curable ink jet ink may be 1.0% to 10% by mass, for example, 2.0% to 8.0% by mass or 4.0% to 6.0% by mass, relative to the total mass of the ink. The radiation-curable ink jet ink containing such an amount of vinyl group-containing (meth)acrylate tends to improve blocking resistance or shrink properties or exhibit improved curability.

### (1-2-2) Other Multifunctional (Meth)Acrylate

Examples of other multifunctional (meth)acrylates include bifunctional (meth)acrylates, such as dipropylene glycol di(meth)acrylate, diethylene glycol di(meth)acrylate, triethylene glycol di(meth)acrylate, tetraethylene glycol di(meth)acrylate, polyethylene glycol di(meth)acrylate, dipropylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, bisphenol A ethylene oxide (EO) adduct di(meth)acrylate, bisphenol A propylene oxide (PO) adduct di(meth)acrylate, hydroxypivalic acid neopentyl glycol di(meth)acrylate, and polytetramethylene glycol di(meth)acrylate; and trifunctional or more multifunctional (meth)acrylates, such as trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glyceryl propoxy tri(meth)acrylate, caprolactone-modified trimethylolpropane tri(meth)acrylate, pentaerythritolethoxy tetra(meth)acrylate, and caprolactam-modified dipentaerythritol hexa(meth)acrylate.

In some embodiments, dipropylene glycol diacrylate (DPGDA) is used. Such a multifunctional (meth)acrylate tends to improve curability and rub resistance and reduce the viscosity of the ink.

The multifunctional (meth)acrylate content of the radiation-curable ink jet ink may be 2.5% to 17.5% by mass, for example, 5.0% to 15% by mass or 7.5% to 12.5% by mass, relative to the total mass of the ink. The radiation-curable ink jet ink containing such an amount of multifunctional (meth)acrylate tends to exhibit improved curability and reduced viscosity.

### (2) Polymerization Initiator

The polymerization initiator is a photopolymerization initiator that produces active species when irradiated with radiation and is not otherwise limited. For example, the polymerization initiator may be a known polymerization initiator, such as an acylphosphine oxide-based polymerization initiator, an alkylphenone-based polymerization initiator, a titanocene-based polymerization initiator, or a thioxanthone-based polymerization initiator. In some embodiments, an acylphosphine oxide-based polymerization initiator or a thioxanthone-based polymerization initiator may be used, particularly an acylphosphine oxide-based polymerization initiator. Such a polymerization initiator tends to further improve the curability of the radiation-curable ink jet ink. A polymerization initiator may be used independently, or two or more polymerization initiators may be used in combination.

The polymerization initiator content of the radiation-curable ink jet ink may be 2.5% to 17.5% by mass, for example, 5% to 15% by mass or 7.5% to 12.5% by mass, relative to the total mass of the ink. The radiation-curable ink jet ink containing such an amount of polymerization initiator tends to exhibit improved curability.

Examples of acylphosphine oxide-based polymerization initiators include, but are not limited to, 2,4,6-trimethylbenzoyldiphenylphosphine oxide, bis(2,4,6-trimethylbenzoyl)phenylphosphine oxide, and bis(2,6-dimethoxybenzoyl)-2,4,4-trimethylpentylphosphine oxide.

Commercially available acylphosphine oxide-based polymerization initiators include, but are not limited to, Omnirad 819 (bis(2,4,6-trimethylbenzoyl)phenylphosphine oxide), IRGACURE 1800 (mixture of bis(2,6-dimethoxybenzoyl)-2,4,4-trimethylpentylphosphine oxide and 1-hydroxycyclohexyl phenyl ketone in a mass ratio of 25:75), and SpeedCure TPO (2,4,6-trimethylbenzoyldiphenylphosphine oxide), for example.

### (3) Sensitizer

The radiation-curable ink jet ink may contain a sensitizer. The sensitizer may be, but is not limited to, a thioxanthone-based compound. Examples of the thioxanthone-based compound include, but are not limited to, thioxanthone, diethylthioxanthone, isopropylthioxanthone, and chlorothioxanthone.

Commercially available thioxanthone-based sensitizers include, but are not limited to, SpeedCure DETX (2,4-diethylthioxanthen-9-one) and SpeedCure ITX (2-isopropylthioxanthone), both produced by Lambson Group Ltd., and KAYACURE DETX-S (2,4-diethylthioxanthone) produced by Nippon Kayaku Co., Ltd.

When the radiation-curable ink jet ink contains a sensitizer, the sensitizer content may be 0.5% to 7.5% by mass, for example, 1.5% to 5.0% by mass or 2.5% to 3.5% by mass, relative to the total mass of the ink. The radiation-curable ink jet ink containing such an amount of sensitizer tends to exhibit improved curability.

### (4) Polymerization Inhibitor

The radiation-curable ink jet ink may contain a polymerization inhibitor. Examples of the polymerization inhibitor include, but are not limited to, p-methoxyphenol, hydroquinone monomethyl ether (MEHQ), 4-hydroxy-2,2,6,6-tetramethylpiperidine-N-oxyl, hydroquinone, cresol, t-butylcatechol, 3,5-di-t-butyl-4-hydroxytoluene, 2,2′-methylenebis(4-methyl-6-t-butylphenol), 2,2′-methylenebis(4-ethyl-6-butylphenol), 4,4′-thiobis(3-methyl-6-t-butylphenol), hindered amine compounds, and derivatives of 2,2,6,6-tetramethylpiperidine-1-oxyl, 2,2,6,6-tetramethyl-4-hydroxypiperidine-1-oxyl (LA-7RD), or 2,2,6,6-tetramethylpiperidine-1-oxyl.

When the radiation-curable ink jet ink contains a polymerization inhibitor, the polymerization inhibitor content may be 0.1% to 0.7% by mass, for example, 0.2% to 0.5% by mass, relative to the total mass of the ink. The radiation-curable ink jet ink containing such an amount of polymerization inhibitor tends to have improved storage stability.

### (5) Surfactant

The radiation-curable ink jet ink may contain a surfactant. The surfactant may be, but is not limited to, an acetylene glycol-based surfactant, a fluorosurfactant, or a silicone surfactant.

Examples of the acetylene glycol-based surfactant include, but are not limited to, 2,4,7,9-tetramethyl-5-decyne-4,7-diol and its alkylene oxide adducts; and 2,4-dimethyl-5-decyne-4-ol and its alkylene oxide adducts.

Examples of the fluorosurfactant include, but are not limited to, perfluoroalkylsulfonic acid salts, perfluoroalkylcarboxylic acid salts, perfluoroalkylphosphoric acid esters, perfluoroalkylethylene oxide adducts, perfluoroalkylbetaines, and perfluoroalkylamine oxides.

The silicone surfactant may be a polysiloxane compound, a polyester-modified silicone, or polyether-modified silicone. Examples of the polyester-modified silicone include BYK-347, BYK-348, BYK—UV 3500, BYK—UV 3510, and BYK—UV 3530 (all produced by BYK Additives & Instruments). The polyether-modified silicone may be BYK-3570 (produced by BYK Additives & Instruments).

When the radiation-curable ink jet ink contains a surfactant, the surfactant content may be 0.1% to 1.0% by mass, for example, 0.2% to 0.8% by mass, relative to the total mass of the ink. The radiation-curable ink jet ink containing such an amount of surfactant tends to exhibit improved wettability.

### (6) Coloring Material

The radiation-curable ink jet ink may further contain a coloring material. The radiation-curable ink jet ink containing a coloring material can be used as a colored ink.

When the radiation-curable ink jet ink contains a coloring material, the coating of the ink can form an image with better color. In some embodiments in which the radiation-curable ink jet ink contains a coloring material, the coloring material is selected so that the coating of the ink will be opaque. Thus, the object to be labeled with the shrink film 100, that is, the object to be wrapped, can be easily hidden.

The coloring material may be at least a pigment or a dye. Examples of the coloring material that can be used will be presented below.

Inorganic pigments include carbon blacks (C.I. (Color Index Generic Name) Pigment Black 7), such as furnace black, lamp black, acetylene black, and channel black; and iron oxide and titanium oxide.

Organic pigments include azo pigments, such as insoluble azo pigments, condensed azo pigments, azo lake, and chelate azo pigments; polycyclic pigments, such as phthalocyanine pigments, perylene and perinone pigments, anthraquinone pigments, quinacridone pigments, dioxane pigments, thioindigo pigments, isoindolinone pigments, and quinophthalone pigments; dye chelates, such as basic dye chelates and acid dye chelates; dye lakes, such as basic dye lakes and acid dye lakes; and nitro pigments, nitroso pigments, aniline black, and daylight fluorescent pigments.

The total amount of coloring materials in the radiation-curable ink jet ink can be varied according to the use and may be 0.5% to 15% by mass, for example, 1.0% to 10% by mass or 1.5% to 5.0% by mass, relative to the total mass of the ink. In an embodiment, the radiation-curable ink jet ink may be a clear ink containing no coloring material or a small amount (e.g., 0.1% by mass or less) of coloring material to the extent that the coloring material is not intended for coloring.

Examples of the dye include, but are not limited to, acid dyes, such as C.I. Acid Yellows, C.I. Acid Reds, C.I. Acid Blues, C.I. Acid Oranges, C.I. Acid Violets, and C.I. Acid Blacks; basic dyes, such as C.I. Basic Yellows, C.I. Basic Reds, C.I. Basic Blues, C.I. Basic Oranges, C.I. Basic Violets, and C.I. Basic Blacks; direct dyes, such as C.I. Direct Yellows, C.I. Direct Reds, C.I. Direct Blues, C.I. Direct Oranges, C.I. Direct Violets, and C.I. Direct Blacks; reactive dyes, such as C.I. Reactive Yellows, C.I. Reactive Reds, C.I. Reactive Blues, C.I. Reactive Oranges, C.I. Reactive Violets, and C.I. Reactive Blacks; and disperse dyes, such as C.I. Disperse Yellows, C.I. Disperse Reds, C.I. Disperse Blues, C.I. Disperse Oranges, C.I. Disperse Violets, and C.I. Disperse Blacks. Such dyes may be used individually or in combination.

### (7) Other Constituents

The radiation-curable ink jet ink may optionally contain additives such as a dispersant for the coloring material or the like.

### (8) Physical Properties and Preparation of Radiation-Curable Ink Jet Ink

The radiation-curable ink jet ink is applied by an ink jet method. In this point of view, the viscosity at 20° C. of the ink may be 1.5 mPa·s to 15 mPa·s, for example, 1.5 mPa·s to 7 mPa·s or 1.5 mPa·s to 5.5 mPa·s.

The surface tension at 25° C. of the radiation-curable ink jet ink is 40 mN/m or less from the viewpoint of appropriately spreading over and wetting the shrink film. In some embodiments, it may be 38 mN/m or less or 35 mN/m or less. Also, the surface tension may be 20 mN/m or more or 25 mN/m or more.

The surface tension can be determined by measuring the ink wetting a platinum plate at 25° C. with an automatic surface tensiometer CBVP—Z (manufactured by Kyowa Interface Science).

The radiation-curable ink jet ink may be prepared by mixing the above-described constituents in an arbitrary order and, optionally, removing impurities by, for example, filtration. For mixing, the constituents may be added one after another into a container equipped with a stirring device, such as a mechanical stirrer or a magnetic stirrer, followed by stirring. Filtration may be performed as required by, for example, centrifugal filtration or using a filter.

The radiation-curable ink jet ink is cured by irradiating its coating with radiation. The cured coating is harder than, for example, coatings made of aqueous inks and is accordingly more likely to crack when the first region having the coating shrinks together with the shrink film. However, the shrink film disclosed herein has the second region, and the presence of the second region reduces or prevents the shrinkage of the first region, thereby reducing cracks.

### 1. 5. Advantages

In the shrink film disclosed herein, the second region shrinks preferentially to the first region when heated. Probably, the cause of this phenomenon is mainly that the larger the total thickness of the shrink film and the coating of the radiation-curable ink jet ink, the less likely it is to shrink. Additionally, this phenomenon is probably caused by, in part, the hardness of the coating of the radiation-curable ink jet ink, which suppresses the shrinkage of the film.

Thus, when the shrink film is shrunk by heat, the first region is less likely to shrink than the second region, and accordingly, cracks in the coating of the radiation-curable ink jet ink formed in the first region can be reduced. Additionally, in the shrink film, the preferential shrinkage of the second region to the first region allows smaller shrinkage of the first region, thereby reducing distortion of the image of the coating formed in the first region resulting from the shrinkage.

FIG. 2 is a schematic illustrative representation of a shrink film according to an embodiment before and after shrinkage by heat. The upper side of FIG. 2 illustrates a shrink film 100 before heating, and the lower side illustrates the shrink film 100 after heating. In the shrink film 100 of the illustrated embodiment, the second region 120 shrinks, thereby suppressing the shrinkage of the image 114 in the first region 110, as illustrated in FIG. 2. Consequently, the image 114 hardly changes between before and after shrinkage. Thus, the shrink film can eliminate or simplify the need to edit the image 114 in the first region 110 to allow for the amount of shrinkage.

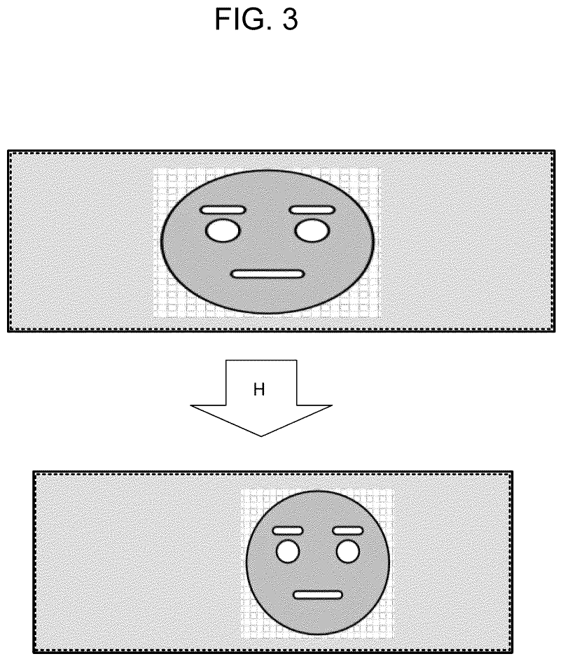

FIG. 3 is a schematic illustrative representation of a known shrink film before and after shrinkage by heat. The upper side of FIG. 3 illustrates a known shrink film before heating, and the lower side illustrates the shrink film after heating. In the known shrink film in FIG. 3, the image changes between before and after shrinkage. Accordingly, the coating of the known shrink film is likely to crack. Additionally, the known shrink film requires the design of images allowing for the amount of shrinkage.

### 2. Container

The container disclosed herein includes a container body and the above-described shrink film disposed on the periphery of the container body by heat shrinking. The shrink film 100 may be cylindrical with the third and fourth sides 103 and 104 joined. The shrink film with the container body placed within the cylinder thereof is heated, and the second region 120 of the shrink film 100 shrinks in the first direction X, thereby attaching the shrink film on the periphery of the container body.

When the third and fourth sides 103 and 104 of the shrink film 100 are joined, a joint is formed. The joint may be formed using an adhesive or by heat fusion, and the joint belongs neither to the first region nor the second region.

Examples of the container body include bottles made of polymers, such as polyethylene terephthalate (PET), polyethylene, or polypropylene, jars made of glass, and cans made of metal. The container may hold liquid or powder. In some embodiments, the container is a liquid container adapted to hold liquid. In an embodiment in which the container is for a liquid, the second region of the shrink film can be a liquid level visible portion through which the liquid in the container can be seen from the outside. Such a second region allows the amount of liquid in the container to be seen from the outside.

The container disclosed herein, to which an image formed of the above-described radiation-curable ink jet ink is labeled, can be a container with a durable label attached.

### 3. Ink Jet Printing Apparatus

The ink jet printing apparatus disclosed herein includes a head that ejects the radiation-curable ink jet ink and a control unit that controls the head. The control unit performs a printing mode of applying the radiation-curable ink jet ink onto a film that is shrunk in a first direction by heat and has a quadrilateral shape in plan view with a first and a second side extending in the first direction. In the printing mode, the control unit forms a first region that is defined by a contour including a portion of the first side and a portion of the second side in plan view and has a coating of the radiation-curable ink jet ink formed therein, and a second region that has a rectangular shape in plan view with two opposing sides defined by a portion of the first side and a portion of the second side and has no coating of the radiation-curable ink jet ink or a coating of the radiation-curable ink jet ink formed therein with a smaller thickness than the coating in the first region.

The ink jet printing apparatus according to an embodiment includes a print head that applies a UV-curable ink onto the shrink film to form a coating, and a UV irradiation device that irradiates the coating with radiation to cure the coating and thus form a cured coating.

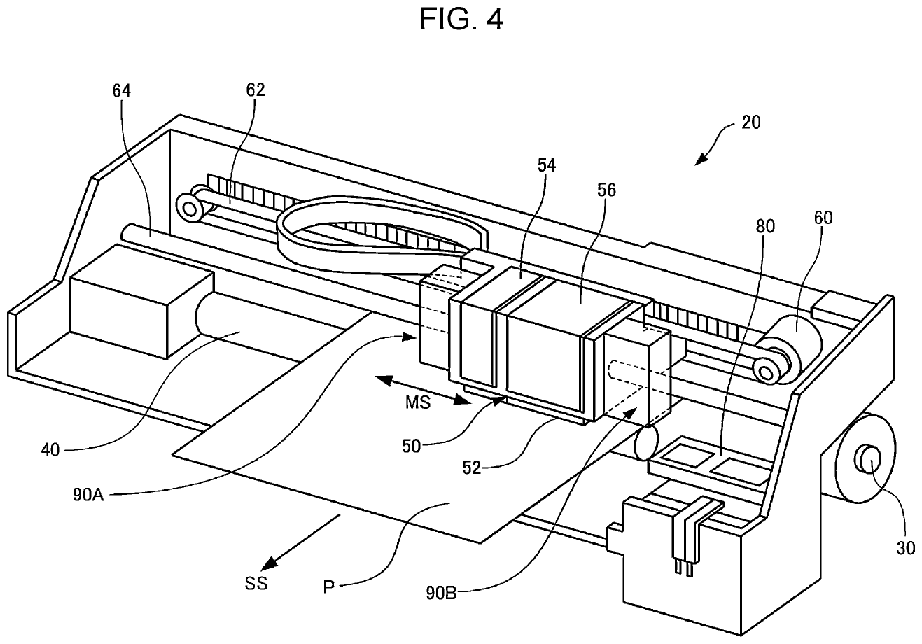

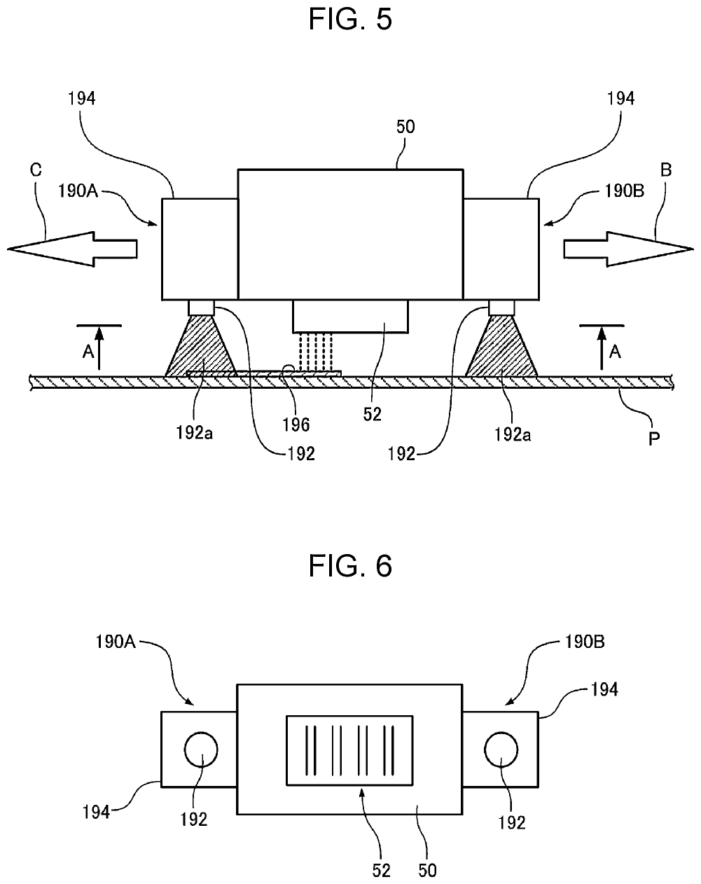

For producing the shrink film disclosed herein, the ink jet printing apparatus depicted in FIG. 4 may be used, for example. FIG. 4 is a perspective view of an ink jet printing apparatus that can be used to produce the shrink film disclosed herein. FIG. 5 is a front view of UV irradiation devices 90A (190A in FIG. 5) and 90B (190B in FIG. 5) depicted in FIG. 4. FIG. 6 is an illustrative representation of the devices in FIG. 5 viewed in the direction of arrows A.

The ink jet printing apparatus 20 depicted in FIG. 4 includes a motor 30 operable to transport a shrink film P in a sub-scanning direction SS, a platen 40, a print head 52 operable to eject very small droplets of the UV-curable ink through the head nozzles onto the shrink film P, a carriage 50 in which the print head 52 is mounted, a carriage motor 60 operable to move the carriage 50 in a main scanning direction MS, and a pair of UV irradiation devices 90A and 90B operable to irradiate droplets of the UV-curable ink applied onto the shrink film P from the print head 52 with UV light.

The carriage 50 is drawn by a traction belt 62 driven by the carriage motor 60, thereby moving along a guide rail 64.

The print head 52, which is mounted in the carriage 50, is moved in the main scanning direction MS by the movement of the carriage 50 in the scanning direction MS.

The print head 52 is operable to eject the UV-curable ink. In the embodiment illustrated in FIG. 1, the print head 52 is a full-color printing serial head operable to eject four color inks, each ejected through a plurality of nozzles assigned to the color ink. In the carriage 50 in which the print head 52 is mounted, a black cartridge 54 that is a black ink container charged with a black ink to be fed to the print head 52 and a color ink cartridge 56 that is a color ink container charged with a color ink to be fed to the print head 52 are also mounted in addition to the print head 52. The inks in the cartridges 54 and 56 are UV-curable inks that are implementations of the above-described radiation-curable ink jet ink.

The carriage 50 is provided with a capping device 80 at the home position of the carriage (on the right side in FIG. 4). The capping device 80 seals nozzle face of the print head 52 when the printing operation is stopped. On completing a printing operation, the carriage 50 returns to the position right above the capping device 80, and a mechanism (not depicted) automatically lifts the capping device 80 to seal the nozzle face of the print head 52. This capping operation prevents the ink in the nozzles from drying or deteriorating. The position of the carriage 50 is controlled, for example, so as to be accurately aligned with the position of the capping device 80.

The ink jet printing apparatus 20 having such a structure can eject and apply droplets of the UV-curable inks onto the shrink film to form a coating on the shrink film. The ink jet printing apparatus 20 continuously operates the formation of a coating and the curing of the coating in a single body without using individual devices for the respective operations.

For irradiation with UV light, the UV irradiation devices depicted in FIGS. 4 and 5 may be used.

The UV irradiation devices 190A and 190B are disposed on both ends of the carriage 50 in the direction in which the carriage 50 moves, as depicted in FIGS. 4 to 6.

The UV irradiation device 190A to the observer's left of the print head 52 irradiates the droplets ejected onto the shrink film P with UV light during scanning in the right direction performed by the carriage 50 moving to the right (in the direction indicated by arrow B in FIG. 5) as depicted in FIG. 5. Also, the UV irradiation device 190B to the observer's right of the print head 52 irradiates the droplets ejected onto the shrink film P with UV light during scanning in the left direction performed by the carriage 50 moving to the left (in the direction indicated by arrow C in FIG. 5).

The UV irradiation devices 190A and 190B, which are attached to the carriage 50, each include a housing 194 holding a UV light source 192, aligned with the UV light source in the other housing, and a light source control circuit (not depicted) operable to control the turn-on and turn-off of the UV light source 192. In the embodiment illustrated in FIGS. 5 and 6, the UV irradiation devices 190A and 190B are each provided with a single UV light source 192. In another embodiment, however, each irradiation device may have two or more UV light sources. In some embodiments, the UV light source 192 is either an LED (light emitting diode) or an LD (laser diode). Such a light source does not require a filter or the like unlike other UV light sources such as mercury lamps and metal halide lamps, accordingly avoiding the increase in size of the light source due to the filter or the like. Also, the UV light maintains its intensity so as to efficiently cure the UV-curable ink without a decrease in intensity because the UV light is not absorbed by the filter.

The wavelengths of the radiation emitted from the UV light sources 192 may be the same or different. When the UV-light sources 192 are LEDs or LDs, the wavelength of the UV light emitted can be in the range of about 350.0 nm to 430.0 nm.

When the UV irradiation devices 190A and 190B are used, the UV light sources 192 emit UV light 192a to the portion of the shrink film P in the vicinity of the print head 52 and thus irradiate droplets applied onto the shrink film P by the ejection from the print head 52, as depicted in FIG. 4, thereby curing at least the surface of the droplets to form an image.

The general operation of the ink jet printing apparatus 20 is controlled by a control unit (not depicted). The control unit performs a printing mode of applying the radiation-curable ink jet ink onto the above-described shrink film. In the printing mode, the control unit forms, in the shrink film, a first region that is defined by a contour including a portion of the first side and a portion of the second side in plan view and has a coating of the radiation-curable ink jet ink formed therein, and a second region that has a rectangular shape in plan view with two opposing sides defined by a portion of the first side and a portion of the second side and has no coating of the radiation-curable ink jet ink or a coating of the radiation-curable ink jet ink formed therein with a smaller thickness than the coating in the first region.

The ink jet printing apparatus disclosed herein can produce such a shrink film, in which the second region shrinks preferentially to the first region. This leads to reduced cracks in the coating of the radiation-curable ink jet ink formed in the first region when the resulting shrink film is shrunk. Additionally, in the resulting shrink film, the preferential shrinkage of the second region to the first region allows smaller shrinkage of the first region, thereby reducing distortion of the image formed in the first region resulting from the shrinkage. Thus, the shrink film can eliminate or simplify the need to edit the image in the first region to allow for the amount of shrinkage.

The implementation of the present disclosure includes, for example, substantially the same function, method, and results or purpose and effect as in any of the disclosed embodiments. Some elements used in the disclosed embodiments but not essential may be replaced. Implementations capable of producing the same effect as produced in the disclosed embodiments or achieving the same object as in the disclosed embodiments are also within the scope of the subject matter of the present disclosure. A combination of any of the disclosed embodiments with a known art is also within the scope of the subject matter of the present disclosure.

The above-described embodiments and modifications derive the following.

A shrink film is shrunk in a first direction by heat and has a quadrilateral shape in plan view with a first and a second side extending in the first direction. The shrink film includes, in plan view, a first region that is defined by a contour including a portion of the first side and a portion of the second side and has a coating of a radiation-curable ink jet ink formed therein, and a second region that has a rectangular shape with two opposing sides defined by a portion of the first side and a portion of the second side and has no coating of the radiation-curable ink jet ink or a coating of the radiation-curable ink jet ink formed therein with a smaller thickness than the coating in the first region.

In the shrink film, the second region shrinks preferentially to the first region. This reduces cracks in the coating of the radiation-curable ink jet ink formed in the first region when the shrink film is shrunk. Additionally, in the shrink film, the preferential shrinkage of the second region to the first region allows smaller shrinkage of the first region, thereby reducing distortion of the image of the coating formed in the first region resulting from the shrinkage. Thus, the shrink film can eliminate or simplify the need to edit the image in the first region to allow for the amount of shrinkage.

In the shrink film, the length of the second region in the first direction may be 1/20 to ⅕ of the length of the shrink film in the first direction.

Such a shrink film can ensure a sufficient amount of shrinkage as well as reduce cracks in the coating of the radiation-curable ink jet ink formed in the first region.

In the shrink film, the coating of the radiation-curable ink jet ink in the first region may form an image.

Such a shrink film can be a label with higher design aesthetics.

In the shrink film, the coating of the radiation-curable ink jet ink may contain a coloring material.

Such a shrink film can have an image with better color.

In the shrink film, the coating of the radiation-curable ink jet ink may be opaque.

Such a shrink film can easily hide the object to be labeled with the shrink film.

In the shrink film, the second region may have no coating of the radiation-curable ink jet ink.

In such a shrink film, the second region shrinks preferentially to the first region, thereby reducing cracks in the coating of the radiation-curable ink jet ink formed in the first region.

In the shrink film, the coating of the radiation-curable ink jet ink in the first region may have a thickness of 5 μm or more.

In such a shrink film, the first region is less likely to shrink, thus reducing cracks in the coating of the radiation-curable ink jet ink formed in the first region.

In the shrink film, the coating of the radiation-curable ink jet ink in the second region may have a thickness of less than 5 μm.

In such a shrink film, the second region is more likely to shrink, thereby resulting in reduced cracks in the coating of the radiation-curable ink jet ink formed in the first region.

The shrink film may contain polyethylene terephthalate.

Such a shrink film tends to shrink to a larger degree.

A container includes the above-described shrink film on the periphery thereof in a state shrunk by heat.

The container is labeled using the radiation-curable ink jet ink, thus having a durable label.

The container may be for a liquid.

In the container, the second region may be a portion through which the level of the liquid is visible.

Such a container allows the amount of liquid in the container to be seen from the outside through the second region.

The ink jet printing apparatus includes a head that ejects a radiation-curable ink jet ink and a control unit that controls the head. The control unit performs a printing mode of applying the radiation-curable ink jet ink onto a film that is shrunk in a first direction by heat and has a quadrilateral shape in plan view with a first and a second side extending in the first direction. In the printing mode, the control unit forms a first region that is defined by a contour including a portion of the first side and a portion of the second side in plan view and has a coating of the radiation-curable ink jet ink formed therein, and a second region that has a rectangular shape in plan view with two opposing sides defined by a portion of the first side and a portion of the second side and has no coating of the radiation-curable ink jet ink or a coating of the radiation-curable ink jet ink formed therein with a smaller thickness than the coating in the first region.

The ink jet printing apparatus can produce such a shrink film, in which the second region shrinks preferentially to the first region. This leads to reduced cracks in the coating of the radiation-curable ink jet ink formed in the first region when the resulting shrink film is shrunk. Additionally, in the resulting shrink film, the preferential shrinkage of the second region to the first region allows smaller shrinkage of the first region, thereby reducing distortion of the image of the coating formed in the first region resulting from the shrinkage. Thus, the shrink film can eliminate or simplify the need to edit the image in the first region to allow for the amount of shrinkage.

What is claimed is:

1. A shrink film that is shrunk in a first direction by heat and has a quadrilateral shape with a first and a second side extending in the first direction in plan view, the shrink film comprising, in plan view:
a first region that is defined by a contour including a portion of the first side and a portion of the second side and has a coating of a radiation-curable ink jet ink formed therein; and
a second region that has a rectangular shape with two opposing sides defined by a portion of the first side and a portion of the second side and has no coating of the radiation-curable ink jet ink or a coating of the radiation-curable ink jet ink with a smaller thickness than the coating in the first region.

2. The shrink film according to claim 1, wherein the second region, in the first direction, has a length of 1/20 to ⅕ of the length of the shrink film.

3. The shrink film according to claim 1, wherein the coating of the radiation-curable ink jet ink in the first region forms an image.

4. The shrink film according to claim 3, wherein the coating of the radiation-curable ink jet ink contains a coloring material.

5. The shrink film according to claim 1, wherein the coating of the radiation-curable ink jet ink is opaque.

6. The shrink film according to claim 1, wherein the second region has no coating of the radiation-curable ink jet ink.

7. The shrink film according to claim 1, wherein the coating of the radiation-curable ink jet ink in the first region has a thickness of 5 μm or more.

8. The shrink film according to claim 1, wherein the coating of the radiation-curable ink jet ink in the second region has a thickness of less than 5 μm.

9. The shrink film according to claim 1, wherein the shrink film contains polyethylene terephthalate.
